(19) United States
(12) Patent Application Publication
(10) Pub. No.: US 2006/0184361 A1
(43) Pub. Date: Aug. 17, 2006

(54) Method and apparatus for reducing an interference noise signal fraction in a microphone signal

(76) Inventor: Markus Lieb, Gifhorn (DE)

Correspondence Address: PHILIPS INTELLECTUAL PROPERTY & STANDARDS, P.O. BOX 3001, BRIARCLIFF MANOR, NY, 10510, US

(21) Appl. No.: 10/552,054

(22) PCT Filed: Mar. 26, 2004
(86) PCT No.: PCT/IB04/01025

§ 371 Date: Oct. 4, 2005

(30) Foreign Application Priority Data
Apr. 8, 2003 (EP) 03100947.5

(51) Int. Cl. G10L 15/20

(52) U.S. Cl. 704/233

(57) ABSTRACT

The invention discloses a method of reducing an interference noise signal fraction in a microphone signal, which method is based on estimating the interference noise signal fraction from a virtually pure interference noise signal and does not require any additional microphones. It is an essential feature of the method according to the invention that the signal which is used as a basis for estimating the interference noise signal fraction in the microphone signal of interest is received by means of one or more inversely operated loudspeakers. There is no need to install further microphones, particularly in situations where there are already one or more loudspeakers as components of an audio system. Such a situation arises for example in any motor vehicle fitted with an audio system.

The invention relates to a method of reducing an interference noise signal fraction in a microphone signal. The invention furthermore relates to an apparatus for reducing an interference noise signal fraction in a microphone signal.

Such methods are highly important in particular for improving the quality of speech signals which are fed to a speech recognition device or to a telecommunications device. One important application example from the telecommunications sector is hands-free devices, which nowadays by law must be used for making telephone calls in motor vehicles. With the aid of such hands-free devices, it is possible for the driver to communicate with a remote conversation partner without having to take his hands off the steering wheel and hence without taking his eyes off the road.

The example of hands-free devices can be used to clearly illustrate the two types of interference noise which are mainly distinguished and the elimination of which from the speech signal transmitted to the remote conversation partner forms the object of the method under consideration.

Firstly there is the interference noise that comes from one or more known sources of sound. In the case of hands-free devices in cars, this is for example the noise produced by the loudspeaker of the hands-free device or by the loudspeakers of an audio system. If, for example, the speech signal of the remote conversation partner that is produced by the loudspeaker of the hands-free device reaches the microphone and is not removed from the microphone signal, then the remote conversation partner will hear an echo of his own voice, and this is perceived as highly unpleasant. The methods used to remove such interference noise fractions from the microphone signal require knowledge of the signal which produces the interference noise. In the example described above, this is the speech signal of the remote conversation partner which is fed to the loudspeaker of the hands-free device. Such methods are described for example in EP 0 948 237 A2 and in DE 41 06 405 A1.

The second type of interference noise includes that noise about the production of which one is not precisely aware and which is generally produced by a large number of sources of noise which are not precisely defined. Typical surrounding noise belongs to this type of interference noise. If the example of a hands-free device in a motor vehicle is again considered, the noise of the car being driven belongs to this type of interference noise. A large group of methods for reducing interference noise of this type are based on estimating the interference noise fraction on the basis of the microphone signal. The interference noise signal fraction in the microphone signal is reduced with the aid of this estimate, for example using the method of spectral subtraction. One method from this group is described for example in U.S. Pat. No. 6,363,345 B1. However, estimating the interference noise fraction from the microphone signal poses the problem that within the microphone signal those sections of noise in which there is only an interference noise signal fraction and no useful signal fraction must be detected. In the case of a hands-free device in a motor vehicle, signal sections such as this which contain no speech signal fraction would be in the microphone signal. As long as such signal sections are present, an additional signal processing step, so-called voice activity detection (VAD), is necessary to detect these signal sections. However, VAD often supplies only unreliable results, particularly in the case of a poor signal-to-noise ratio (SNR) in the microphone signal. Moreover, the assumption must be made that the interference noise signal estimate made in the speech-signal-free section is also valid at later points in time. However, this assumption represents only an inadequate approximation, particularly in the case of interference noise which changes rapidly over time combined with long speech signal sections.

It is therefore an object of the present invention to specify a method for reducing an interference noise signal fraction in a microphone signal, which method allows a good estimate of the interference noise signal fraction and hence a good reduction in the interference noise signal fraction in the microphone signal, with a low signal processing outlay.

The above-mentioned object is achieved according to the invention by a method comprising the steps as claimed in claim 1. The dependent claims contain advantageous refinements and developments of the method as claimed in claim 1.

According to the method of the invention, the interference noise reference signal or interference noise reference signals used as a basis for estimating the interference noise signal fraction in the microphone signal of interest are determined by means of in each case one inversely operated loudspeaker, that is to say a loudspeaker operated as a microphone.

The loudspeaker is suitably positioned such that the signal fraction coming from the interference noise source in the associated interference noise reference signal is at least as high as the signal fraction coming from the speech signal source. If the unit SNR customary in signal processing is used and if the signal fraction coming from the speech signal source is identified within this context as the signal and the signal fraction coming from the interference noise source is identified as noise, then this corresponds to an SNR of less than or equal to zero. The signal fraction coming from the interference noise source in the associated interference noise reference signal is preferably even twice as high as the signal fraction coming from the speech signal source, and this corresponds to an SNR of around −6. By positioning the loudspeaker in this way, the information about the interference noise signal fraction which can be obtained from the loudspeaker signals is only falsified to a slight extent by speech signal fractions. In the method according to the invention there is no need to install additional microphones, particularly in situations where there are already one or more loudspeakers as components of an audio system.

The estimate of the interference noise signal fraction from the loudspeaker signals, which are also referred to as interference noise reference signals, is determined as a function of whether there is just one or a number of such signals, in one or two steps. If there is just one available interference noise reference signal, a method of signal estimation theory, for example a recursive noise estimate, is applied to this signal and hence the estimate of the interference noise signal fraction is determined directly. In the case of more than one interference noise reference signal, in the first step a method of signal estimation theory, for example the recursive noise estimate, is applied to each of these signals and hence in each case a provisional estimate of the interference noise signal fraction is determined. In the second step, these provisional estimates of the interference noise signal fraction are then combined by linear superposition, as a result of which the desired estimate of the interference noise signal fraction is finally obtained. The linear superposition is preferably carried out such that firstly the provisional estimates of the interference noise signal fraction are multiplied by in each case one weighting factor and then the weighted provisional estimates of the interference noise signal fraction that are thus obtained are summed. The weighting factors reflect the transmission channel characteristic of the corresponding loudspeaker signal. In qualitative terms it can be said that the further away the loudspeaker is positioned from the speech signal source, the greater the attenuation of the speech signal in this loudspeaker and consequently the greater the associated weighting factor.

Once the estimate of the interference noise signal fraction has been determined, this is deducted from the microphone signal, for example using optimal filtering, as a result of which the clean microphone signal, that is to say the microphone signal reduced by the interference noise signal fraction, is finally obtained. In the method of optimal filtering, the frequency response of a filter, known as the optimal filter or Wiener filter, is calculated on the basis of the estimate of the interference noise signal fraction and the microphone signal, and the interference noise signal fraction is deducted from the microphone signal by applying this filter to the microphone signal. This may take place both in the time domain and in the frequency domain. Further methods for deducting the interference noise signal fraction from the microphone signal are, for example, spectral subtraction and non-linear spectral subtraction.

In another refinement of the method according to the invention, besides the interference noise reference signals received by the loudspeakers and the estimate of the interference noise signal fraction resulting therefrom, which is referred to hereinbelow as the first estimate, the microphone signal itself is also used to determine a second estimate of the interference noise signal fraction. In a further step, the first and second estimates are then combined by linear superposition, just like the provisional estimates when there are a number of interference noise reference signals, and thus the desired estimate of the interference noise signal fraction is determined.

The most varied uses are conceivable for the clean microphone signal obtained using the method according to the invention. For instance, it may be fed to a telecommunications device and thus be transmitted to a remote conversation partner, as a result of which the quality of the received speech signal is increased for said conversation partner. In a further use, the clean microphone signal may be fed to a speech recognition device, as a result of which the recognition capability of this system is increased.

In a further refinement of the method according to the invention, the microphone signal and the at least one interference noise reference signal are received in a means of transport, for example a motor vehicle, and the loudspeakers used form part of an already existing loudspeaker system. This is particularly advantageous especially in a motor vehicle, since the loudspeakers in that case are generally positioned such that the interference noise signal fraction in the signal received by it is at least as high as the speech signal fraction coming from a speaker sitting in the driver's seat.

The invention furthermore relates to an apparatus for carrying out the method as claimed in claim 1. The apparatus comprises a signal processor on which the determination of the estimate of the interference noise signal fraction and the deduction of this estimate from the microphone signal are carried out. The apparatus furthermore comprises at least one microphone which is coupled to the signal processor. This coupling may be effected for example by means of a line or in a wireless manner, and a so-called codec for the analog/digital conversion of the microphone signal is usually connected in between. The apparatus likewise comprises at least one loudspeaker which is operated as a microphone and is likewise coupled to the signal processor. In this case, too, the coupling may be effected for example by means of a line or in a wireless manner, and a codec for the analog/digital conversion of the loudspeaker signal may be connected in between. Besides the processing steps belonging to the method according to the invention, even more data processing steps may also be carried out on the signal processor. The signal processor may in particular also form part of an already existing data processing device and additionally be used for the method according to the invention.

The invention will be further described with reference to examples of embodiments shown in the drawings to which, however, the invention is not restricted.

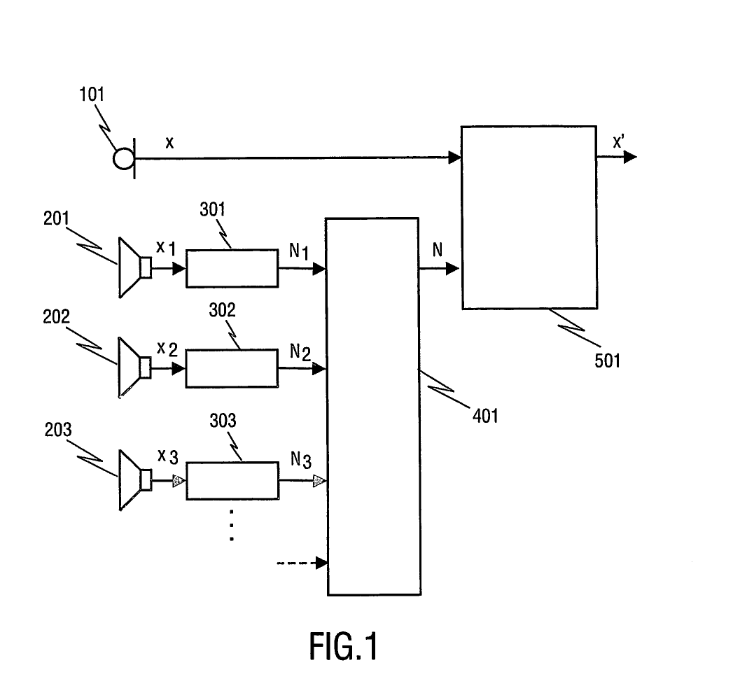

FIG. 1 shows a block diagram to illustrate the method according to the invention.

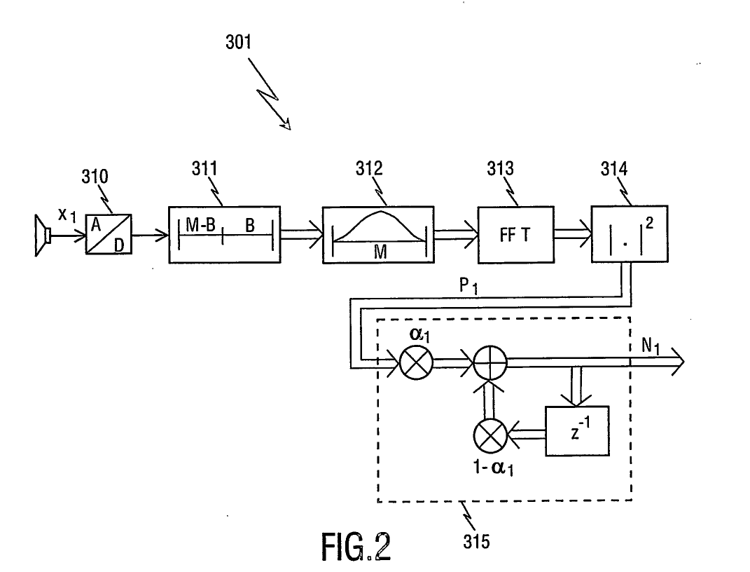

FIG. 2 shows a flowchart which illustrates the determination of a provisional estimate of an interference noise signal fraction.

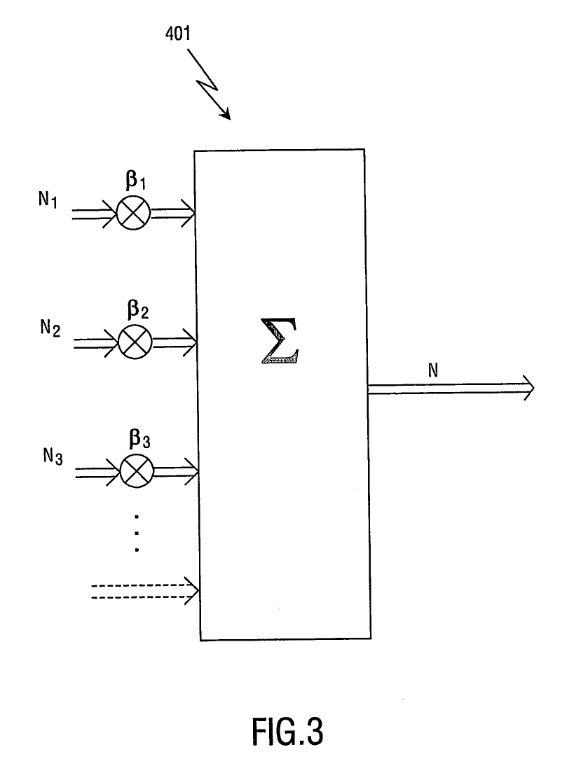

FIG. 3 shows a flowchart which illustrates the combining of the provisional estimates of the interference noise signal fraction for determining an estimate of the interference noise signal fraction.

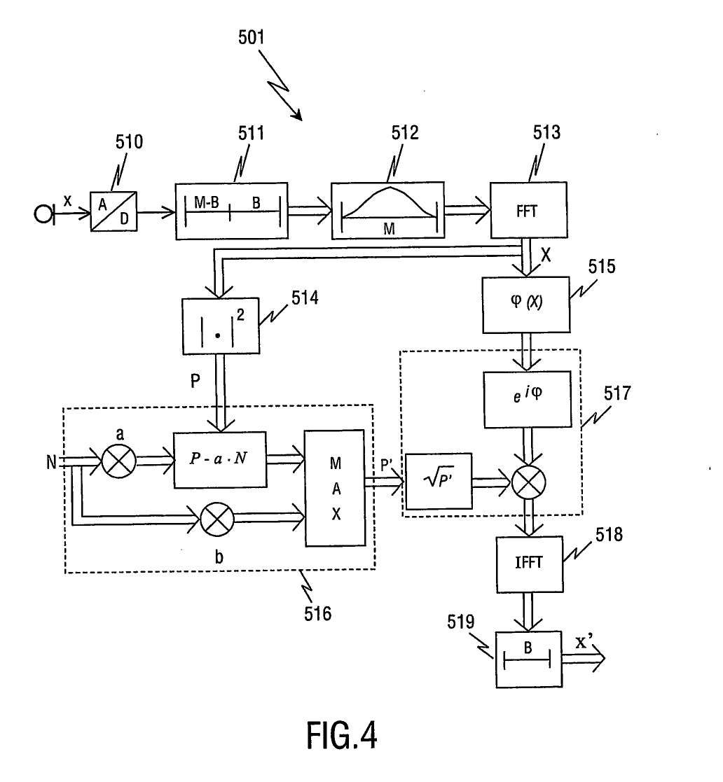

FIG. 4 shows a flowchart which illustrates the deduction of the estimate of the interference noise signal fraction from a microphone signal.

FIG. 1 shows a block diagram of an arrangement for carrying out the method according to the invention. A microphone signal x, which is to be freed of an interference noise signal fraction using the method according to the invention, is recorded using a microphone 101 and fed to a deduction unit 501 which deducts the estimate of the interference noise signal fraction from the microphone signal. Loudspeakers 201, 202 and 203 are used as microphones in a known manner and are used to record interference noise reference signals x₁, x₂ and x₃. The selection, by way of example, of three loudspeakers and accordingly three interference noise reference signals is in no way obligatory. Rather, based on at least one loudspeaker and accordingly one interference noise reference signal, the number may be as desired and is limited at most by the resulting signal processing outlay. The three interference noise reference signals x₁, x₂ and x₃ are then respectively fed to an estimation unit 301, 302 and 303. In these estimation units, in each case a provisional estimate of the interference noise signal fraction is determined. These provisional estimates of the interference noise signal fraction, which are designated N₁, N₂ and N₃ in FIG. 1, are subsequently fed to a combination unit 401. This combination unit 401 combines the provisional estimates of the interference noise signal fraction and thus determines an estimate of the interference noise signal fraction, which is designated N in FIG. 1. This estimate of the interference noise signal fraction is then fed, along with the microphone signal, to the deduction unit 501 as a second input signal. Within this deduction unit 501, the estimate of the interference noise signal fraction is deducted from the microphone signal and thus a clean signal x′ is determined.

FIG. 2 shows a flowchart which illustrates the mode of operation of the estimation unit 301. Within this estimation unit 301, the provisional estimate of the interference noise signal fraction N₁ is calculated from the signal x₁ received by means of the loudspeaker 201. The mode of operation of the estimation units 302 and 303 is thus identical. Firstly, the signal x₁ is digitized by means of an analog/digital conversion 310 at a sampling rate of 8 kHz. Thereafter, a block of M digital sample values of the signal x₁ is formed by means of a so-called framing 311. This block is composed of the last M-B sample values of the previous block and of the last B current sample values of the signal x₁. The signal processing thus takes place in successive blocks comprising M sample values which overlap by M-B sample values, where in each case B current sample values are processed. If M=256 and B=128 are selected, then, at a sampling rate of 8 kHz, a block corresponds to a time duration of 32 ms and the successive blocks overlap by 16 ms, that is to say by 50%. In a subsequent windowing 312, the M sample values of the block are multiplied by the functional values of a window function, for example of a Hamming function, in order at the next transition into the frequency domain to reduce to reduce disruptive influences on account of the framing. The “windowed” sample values determined in this way are then transformed into the frequency domain by means of a discrete Fourier transform 313. In a next processing step 314, the absolute square of the M complex Fourier coefficients is formed, giving the power spectrum P₁(f,i). Here, f is the frequency and i is the index of the current block which is related to the time via the block length and the sampling rate. This power spectrum is then smoothed by means of a recursive smoothing 315 according to the formula
N₁(f,i)=α·N₁(f,i−1)+(1−α)·P₁(f,i)
giving the provisional estimate of the interference noise signal fraction in the frequency domain N₁(f,i). The smoothing filter coefficient α is a parameter of the method that has to be optimized. A typical value for α is for example 0.99. At this point it should be noted that the determination of the provisional estimate of the interference noise signal fraction does not necessarily have to take place in the frequency domain. Rather, implementations in the time domain are also conceivable.

FIG. 3 shows a flowchart to illustrate the mode of operation of the combination unit 401. The provisional estimates of the interference noise signal fraction N₁, N₂ and N₃, which have been determined in the estimation units 301, 302 and 303 in the manner described above, are firstly multiplied in each case by a weighting factor β₁, β₂ and β₃. These weighting factors are again parameters of the method according to the invention that need to be optimized, and they reflect the transmission channel characteristic of the corresponding loudspeaker signal. In qualitative terms it can be said that the further away the loudspeaker is positioned from the speech signal source, the greater the attenuation of the speech signal in this loudspeaker and consequently the greater the associated weighting factor β. Once all the provisional estimates of the interference noise signal fraction have been multiplied by their respective weighting factors, the estimate of the interference noise signal fraction N is given as the sum of these products:

$$N ( f , i ) = {\sum }_{k} {β}_{k} \cdot {N}_{k} ( f , i )$$

It should be noted that in the case of just one loudspeaker and accordingly just one interference noise reference signal, the processing step within the estimation unit 401 is omitted and the provisional estimate of the interference noise signal fraction N₁(f,i) is identical to the estimate of the interference noise signal fraction N(f,i).

FIG. 4 uses a flowchart to illustrate the mode of operation of the deduction unit 501 in which the last step of the method according to the invention, the deduction of the estimate of the interference noise signal fraction from the microphone signal, is carried out. Firstly, the microphone signal x, analogously to the loudspeaker signal x₁ in FIG. 2, is subjected to analog/digital conversion 510, framing 511, windowing 512, transformation into the frequency domain 513 and calculation of the power spectrum P(f,i) 514 as an absolute square of the complex Fourier coefficients. Besides the power spectrum, in a processing step 515 the phase φ(f,i) of the complex Fourier coefficients X is then also calculated. A clean power spectrum P′(f,i) is then calculated from the estimate of the interference noise signal fraction N(f,i) determined in the combination unit 401 and from the power spectrum of the microphone signal P(f,i), by means of a non-linear spectral subtraction 516 according to the formula
P′(f,i)=max{P(f,i)−a(f,i)·N(f, i), b·N(f,i)}
Here, the so-called overestimation factor a(f,i) and the so-called floor factor b are parameters of the method according to the invention that have to be optimized. In respect of the method of non-linear spectral subtraction, reference should be made to Bouquin, R. L., “Enhancement of noisy speech signals: Applications to mobile radio communications”, Speech Communication, Vol. 18, 1996. In the processing step 517, a clean spectrum of complex Fourier coefficients X′(f,i) is then calculated from the clean power spectrum and the previously calculated unchanged phase φ(f,i), according to the equation
X′(f,i)=\sqrt{P′(f,i)}·e^{i-φ(f,i)}
Finally, the clean microphone signal x′ is obtained from this clean spectrum following an inverse Fourier transform 518 and a procedure 519 that is the inverse of framing, according to the so-called overlap-add method. At this point it should again be noted that a subtraction method in the frequency domain does not necessarily have to be selected, but rather methods in the time domain are also conceivable.

1. A method of reducing an interference noise signal fraction in a microphone signal which contains the interference noise signal fraction coming from at least one interference noise source and a speech signal fraction coming from a speech signal source, said method comprising the following steps:
reception of the microphone signal containing the interference noise signal fraction and the speech signal fraction,
reception of at least one interference noise reference signal by means of in each case one inversely operated loudspeaker, where the loudspeaker or loudspeakers are positioned such that the signal fraction coming from the interference noise sources in the respective interference noise reference signal is at least as high as the signal fraction coming from the speech signal source in this interference noise reference signal,
in the case of just one interference noise reference signal, determination of an estimate of the interference noise signal fraction from the interference noise reference signal using a method of signal estimation theory,
in the case of more than one interference noise reference signal, determination of in each case one provisional estimate of the interference noise signal fraction from each of the interference noise reference signals using a method of signal estimation theory and subsequent determination of the estimate of the interference noise signal fraction in the microphone signal by combining these provisional estimates of the interference noise signal fraction,
reduction of the interference noise signal fraction in the microphone signal by deducting the estimate of the interference noise signal fraction from the microphone signal.

2. A method as claimed in claim 1, characterized in that in an additional method step, besides the determination of a first estimate of the interference noise signal fraction by means of at least one interference noise reference signal, a determination of a second estimate of the interference noise signal fraction is carried out by means of the microphone signal itself and a third estimate is determined from a linear combination of the first and second estimates of the interference noise signal fraction, and in that the reduction of the interference noise signal fraction in the microphone signal is effected by deducting this estimate from the microphone signal.

3. A method as claimed in claim 1, characterized in that in the case of more than one interference noise reference signal the combination of the provisional estimates of the interference noise signal fraction consists of the multiplication of any provisional estimate of the interference noise signal fraction by in each case one weighting factor and the subsequent summation of the weighted provisional estimates of the interference noise signal fraction that are thus obtained.

4. A method as claimed in claim 1, characterized in that the deduction of the estimate of the interference noise signal fraction from the microphone signal is carried out using optimal filtering.

5. A method as claimed in claim 1, characterized in that the deduction of the estimate of the interference noise signal fraction from the microphone signal is carried out using the method of spectral subtraction.

6. A method as claimed in claim 1, characterized in that the microphone signal reduced by the interference noise signal fraction is fed to a speech recognition device.

7. A method as claimed in claim 1, characterized in that the microphone signal reduced by the interference noise signal fraction is fed to a telecommunications device.

8. A method as claimed in claim 1, characterized in that the microphone signal and the at least one interference noise reference signal are received in a means of transport and the loudspeaker or loudspeakers used form part of a loudspeaker system present in the means of transport.

9. An apparatus for carrying out the method as claimed in claim 1, which comprises at least the following components:
a signal processor for determining the estimate of the interference noise signal fraction and for deducting this estimate from the microphone signal,
at least one microphone which is coupled to the signal processor and is provided as a receiver for the microphone signal,
at least one loudspeaker which is coupled to the signal processor and is provided as a receiver for the interference noise reference signal.
